(19) United States
(12) Patent Application Publication
(10) Pub. No.: US 2014/0201277 A1
(43) Pub. Date: Jul. 17, 2014

(54) SYSTEM, METHODS, AND COMPUTER PROGRAM PRODUCTS FOR CONTEXTUAL COLLABORATIVE UPDATES FOR RECURRING MEETINGS

(71) Applicant: INTERNATIONAL BUSINESS MACHINES CORPORATION, Armonk, NY (US)

(72) Inventors: Lisa Seacat DeLuca, Yorktown Heights, NY (US); Brian Goodman, Yorktown Heights, NY (US)

(73) Assignee: International Business Machines Corporation, Armonk, NY (US)

(21) Appl. No.: 13/744,407

(22) Filed: Jan. 17, 2013

(51) Int. Cl. H04L 29/06

(52) U.S. Cl. CPC H04L 65/403
USPC 709/204

(57) ABSTRACT

A method of informing a first entity of an activity of a second entity. The activity of the second entity during a period between a first time and a second time is tracked, the period between the first time and the second time being between a time of a first meeting and a time of a second meeting. The activity includes a change made by the second entity that is associated with a task, and the tracking is performed by a processor of a computer system. The first entity is informed of the activity of the second entity based on the tracking.

### BACKGROUND OF THE INVENTION

1. Field of the Invention

The present invention generally relates to systems, methods, and computer program products for making a meeting more efficient, and more particularly to systems, methods, and computer program products that provide, prior to the meeting, detailed information to one or more participants of relevant events prior since any previous meeting.

2. Description of the Related Art

In some development tasks, there are groups of people working toward a common goal of finishing the task. These people can function as a cross-functional team throughout multiple phases that may overlap one another. In some instances, a team member may have difficultly planning ahead due to a lack of a clear understanding of what the other team members are doing.

For example, teams of developers use techniques such as “scrum” to handle daily development tracking. Scrum is an iterative and incremental technique for managing projects, such as, for example, software, product, and application development projects.

Scrum meetings are typically fast paced, short in nature, and occur at various points along the way of a project. In general, these meetings aim to allow developers to quickly state 1) what they have worked on since the last meeting; 2) if they have any blockers (e.g., impediments/stumbling blocks) interfering with their ability to accomplish a task; and 3) what they plan on doing until the next meeting.

Since these meetings are fast paced and information intensive, it can be extremely difficult for everyone in the meeting to completely understand what the others are saying. On smaller teams this can result in long winded answers and a feeling of wastefulness, pulling the developer away from their own pressing development tasks.

A developer may attempt to overcome this problem by manually tracking everything they have done since the last meeting in a log. This technique, however, may result in a developer's time being ineffectively utilized and is also prone to user error. Moreover, if a developer does not update the log, then changes go unnoticed.

Further, as is often the case, many tasks may be assigned to a developer. Some of these tasks may require other developers to complete their tasks first before work on the task can begin. Other tasks may block another developer's task from being started or completed. Therefore, it is important that a developer manually update the status of each task they are assigned in a timely fashion.

As more tasks are assigned to a developer, more time will be spent manually updating the status of the tasks and sharing what was actually done with the other developers, and less time can be spent working toward completing the tasks.

Moreover, if a developer attempts to inform the other developers of their progress on a task for a time period occurring from one meeting to the next, it may be difficult for the developer to recall each of their activities (e.g., piece of code the developer touched). As a result, each developer may not be aware of what the other developers are working towards/on. This may result in a developer being unaware of a prior blocker being removed or a new blocker being added. As a result, a developer's time can be unnecessarily wasted.

Accordingly, the present inventors have realized that there a need for a way to simplify meetings such as development status meetings, to thereby attempt to make them more efficient.

### SUMMARY OF THE INVENTION

In view of the foregoing and other exemplary problems, drawbacks, and disadvantages of the conventional methods and structures, an exemplary feature of the present invention is to provide systems, methods, and computer program products for simplifying meetings by providing information based on one or more contextual collaborative tools.

In a summary of the present invention, details of tasks completed/in progress since a previous meeting are tracked and provided to other members of the group. These details are tracked without requiring manual input from the member being tracked and are provided in, for example, a repeating calendar entry, a file that is shared, an update to a collaborative tool, etc.

In a first exemplary aspect, described herein is a method of informing a first entity of an activity of a second entity, including: tracking, using a processor on a computer, the activity of the second entity during a period between a first time and a second time, the period between the first time and the second time being between a time of a first meeting and a time of a second meeting, the activity including a change made by the second entity that is associated with a task, and the tracking being performed by a processor of a computer system; and informing the first entity of the activity of the second entity based on the tracking.

In a second exemplary aspect, also described herein is a method of informing each member of a group of one or more activities of one or more other members of the group, including: tracking, as executed by a processor on a computer, a first activity of the first member of the group, the first activity being associated with a first task and occurring between a time of a first meeting and a time of a second meeting, and the tracking being performed by a processor of a computer system; generating a report regarding the first task based on the first activity of the first member; and sending the report to each member of the group before the second meeting.

In a third exemplary aspect, also described herein is a method of informing each member of a group of an activity of one or more other members of the group that occurs during a period between a first iteration of a reoccurring meeting and a second iteration of the reoccurring meeting, including: determining, using a processor on a computer, for each member of the group whether they are invited to the second iteration of the reoccurring meeting, tracking an activity of each member of the group that is associated with a task, the tracking being performed by a processor of a computer system; and making viewable to each member of the group the activity of every other member of the group, who is invited to the second iteration of the reoccurring meeting, based on the tracking.

In a fourth exemplary aspect, also described herein is a method of updating a level of progress of a task, including: tracking an activity of a first entity for a time period occurring between a first meeting and a second meeting, the activity being related to the task, and the tracking being performed by a processor of a computer system; dynamically updating the level of progress of the task based on the activity of the first entity during the time period; and notifying a second entity having been invited to the second meeting of the updated level progress of the task.

With its unique and novel features, these exemplary aspects of the present invention provide systems, methods, and computer program products that simplifies meetings and make them more efficient with the use of detailed information based on contextual collaborative tools and, which allow for others to more easily follow along during a fast paced meeting. Further, in some exemplary embodiments of the present invention, users are not required to manually track what they have done since the last meeting. Moreover, in some exemplary embodiments of the present invention, users can be supplied with a “cheat sheet” to remind them of open issues, questions they may have since the last meeting.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 depicts a flowchart 100 that illustrates tracking an activity and informing others of the activity, according to an exemplary embodiment of the present invention;

FIG. 2 depicts a flowchart 200 that illustrates tracking an activity and informing others of the activity, according to another exemplary embodiment of the present invention;

FIG. 3 depicts a flowchart 300 that illustrates tracking an activity and informing other of a level of progress based on the activity, according to another exemplary embodiment of the present invention;

FIG. 4 depicts a flowchart 400 that illustrates tracking an activity and informing other of a level of progress based on the activity throughout a reoccurring meeting, according to another exemplary embodiment of the present invention;

FIG. 5 depicts an exemplary system block diagram 500 for implementing the exemplary embodiments shown in FIGS. 1-4;

FIG. 6 depicts a typical hardware system 600 which may be used for implementing the inventive and novel aspects disclosed herein; and

FIG. 7 depicts typical storage media 700, 702 which may be used to store instructions for implementing the inventive and novel aspects disclosed herein.

### DETAILED DESCRIPTION OF EXEMPLARY EMBODIMENTS

The following detailed description describes various features and functions of the disclosed systems, methods and computer program products with reference to the accompanying figures. In the figures, similar systems typically identify similar components, unless context dictates otherwise. The illustrative systems, methods and computer program products are not meant to be limiting. That is, it will be readily understood that certain aspects of the disclosed systems, methods, and computer program products can be arranged and combined in a wide variety of different configurations, all of which are contemplated herein.

Incidentally, various components described below and shown in the drawings as being functional blocks which perform various processes can be implemented in terms of hardware by a processor, a memory, or other circuits or implemented in terms of software by a program or the like recorded or loaded in memory. Thus, as will be understood by those skilled in the art, the functional blocks can be implemented by hardware alone, software alone, or a combination thereof, and are not restricted to any one of them. Also, for ease of understanding, only those components which are needed in order to describe the technique according to the present invention are illustrated in the drawings.

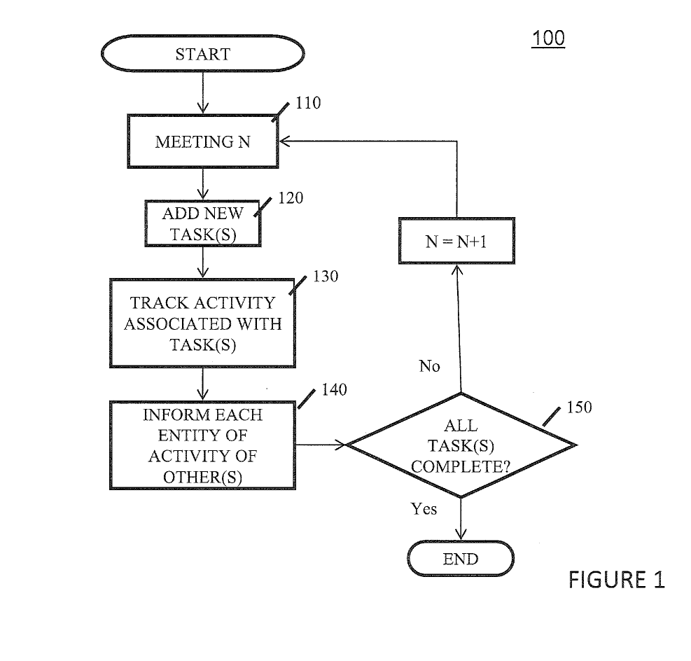

FIG. 1 shows an exemplary embodiment 100 of the present invention for informing one entity of another entity's activity as it relates to a task. At step 110, a meeting N is set and tasks are assigned to one or more entities at step 120. N is equal to 1 for the first meeting. At step 130, information is continually gathered, recorded, and associated with an activity of an entity and a corresponding task.

For example, assume a first task is assigned to a first entity at step 120. The activity of the first entity is tracked at step 130 and associated with the first task. The information related to the activity of the first entity as it relates to the first task can be automatically updated to reflect the activity of the first entity since meeting N.

According to this feature, the entities do not need to manually track everything they have done since the previous meeting. Rather, their activities are dynamically monitored and updated based on their tracked activities.

The tracking at step 130 can be performed using any known method of tracking one's activity. For example, any known contextual collaborative tool can be used. Some exemplary embodiments of the present invention use Rational Team Concert ® by IBM®.

This RTC contextual collaborative tool monitors whether files have been updated and, if so, such changed files are marked as a pending change. The developer can then check on their changes, discard the changes, or deliver the changes. There typically is a dashboard associated with different work items and change sets that allow users to see all the changes that were delivered by all of the developers on the team.

It is noted, however, that the RTC (Rational Team Concert®) tool is only one specific example of a contextual collaborative tool that could be used to implement concepts of the present invention, and the present inventors do not intend that the present invention is limited to specific contextual collaborative tools.

In the context of the present invention, a “contextual collaborative tool” is any of various tools that implement cooperative software that interconnects relevant applications such as word processors, instant messaging, calendars, groupware, etc., into a unified user interface to enhance collaboration. There are various such contextual collaborative tools currently available from such venders as IBM®, Microsoft®, Novell®, Lotus®, and Oracle ®. Thus, in an exemplary aspect, the present invention can be viewed as applying any of these contextual collaborative tools into the application of tracking activities between meetings, such as development meetings and more than one such contextual collaborative tool could be used, once the concepts of the present invention are understood.

At step 140, each of the entities is informed of the other entities' activities since the last meeting N. The entities can be informed via an update to a calendar meeting, a report, a shared file, etc., and this information can be added immediately before a next scheduled meeting, a certain amount of time before the next scheduled meeting, as the information is gathered (e.g., in real-time), etc.

In some exemplary embodiments, the entities can edit, approve, and annotate, add information regarding open questions and issues they may have, etc., the information associated with the activity (or list thereof) that is associated with them before their activities are shared with the other entities.

For example and in continuation of the above example, the first activity of the first entity is reported to the other entities at step 140. In some embodiments, the first entity can edit, approve, and annotate, add information regarding open questions and issues they may have, etc., the information relating to the first activity before sharing it with the other entities. Similarly, these changes can be given to the entity that made them before a meeting.

According to this feature, each entity can be given a brief summary (e.g., a cheat sheet) to remind them about open issues or questions they may have had regarding the work they have performed since the last meeting. Similarly, this brief summary can be given to the other members of the group to inform them of the same.

Similarly, this feature allows the other entities to be provided with a summary of what each of the entities has done since the previous meeting. As a result, when compared with conventional technology, the entities may be more easily able to follow along during a fast paced and information intensive meeting.

At step 150, a determination of whether all tasks are complete is made. If this determination is in the affirmative, then the process ends. If this determination is in the negative, then another meeting is held and the aforementioned process is repeated.

The tracked activity of the entities may be recorded and stored for a member's account. The activity stored in the member's account may be reset, deleted, built upon for the next meeting, archived, etc. after each meeting.

In some exemplary embodiments of the present invention, each entity can manually specify which applications/activities they wish to have tracked. In other embodiments, a moderator specifies the applications/activities they wish to track for each entity. In still other embodiments, one or more activities of the entities are automatically tracked. The activities may include, but are not limited to, development tasks, team deliverables, presentation activities, meeting activities, activity within a team area, etc.

For example, development task activities may include actual code lines that where modified (e.g., changed, added, deleted), a summary of code modified (e.g., changed 10 lines, added 100 new lines, deleted 5 lines, added 3 files, etc.), etc. The team deliverable activities may include, for example, work items, change sets, stories, defects, tasks, action items, goals, etc. The presentation activities may include, for example, activities needing presentation software. The meeting activities may include activities based on a user's calendar, etc. The activity within the team areas may include comments, descriptions added, conversations related to work items, etc.

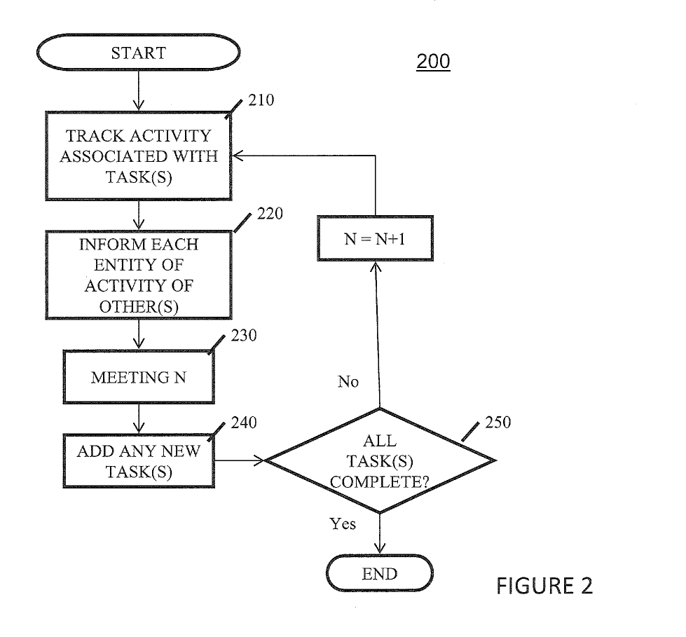

Referring now to FIG. 2, the activities of one or more entities are tracked at step 210 prior to the first meeting at step 230, where N=1. At step 220, each entity is informed of the activity of the one or more entities being tracked prior to the first meeting. This tracking and informing are performed in a same or similar manner to that discussed above. Therefore, a duplicative discussion during the meeting can be avoided or reduced.

At step 240, new task(s), if any, are added to the task(s) that are being tracked. At step 250, it is determined if each of the one or more task(s) is complete. If they are complete, then the process is ended. On the other hand, if they are not complete, then N is incremented by 1 (e.g., a reoccurring meeting is set) and the process is repeated.

This exemplary embodiment allows an initial task or tasks to be delegated to the entities before the first meeting and also allows each entity to be informed of the activities of the other entities before the first meeting. As a result, when compared with conventional technology, each entity can more easily follow along during the initial meeting.

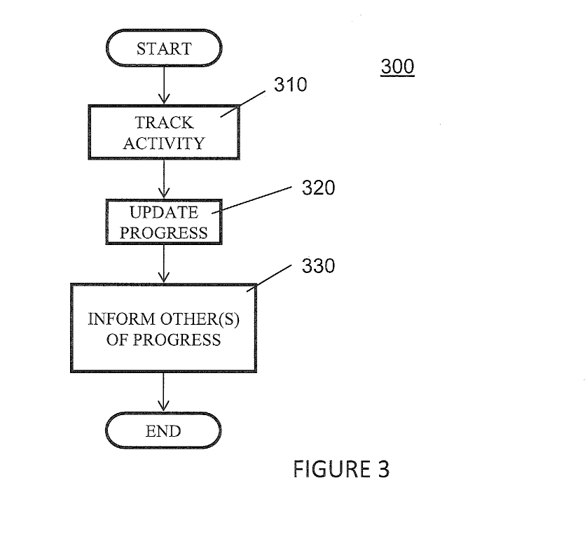

Referring now to FIG. 3, one or more activities of one or more entities are tracked at step 310. The tasks can be identified when the project is set up and can by dynamically updated by, for example, a moderator or any of the entities. A task is associated with an activity of an entity that affects the task. The activity affecting the task is tracked. As explained above, any tool known in the art can be used to track the activity of an entity.

Based on the tracked activity of step 310, the progress of the task is dynamically updated, at step 320. In some exemplary embodiments, the progress of the task is programmatically updated based on a comparison of the progress of the task when the tracking of the activity begins and the progress of the task when the tracking ends. In other exemplary embodiments, the progress of the task is updated in real time as the entity engages in activities and a comparison of the progress of the task when the tracking begins is made with the real time progress.

The progress of a task can be ascertained by, for example, setting one or more milestones (e.g., add 10 lines of code, make code 10% more efficient, make code compliant with an industry regulation, etc.) and determining whether the milestones have been achieved based on the aforementioned comparison.

At step 330, one or more other entities are informed of the progress of each task based on the one or more activities of the one or more entities associated with the task. Similar to the discussion above, each tracked entity can edit, approve, annotate, add information regarding open questions and issues they may have, etc., before the other entities are information of the progress of a task associated with that entity.

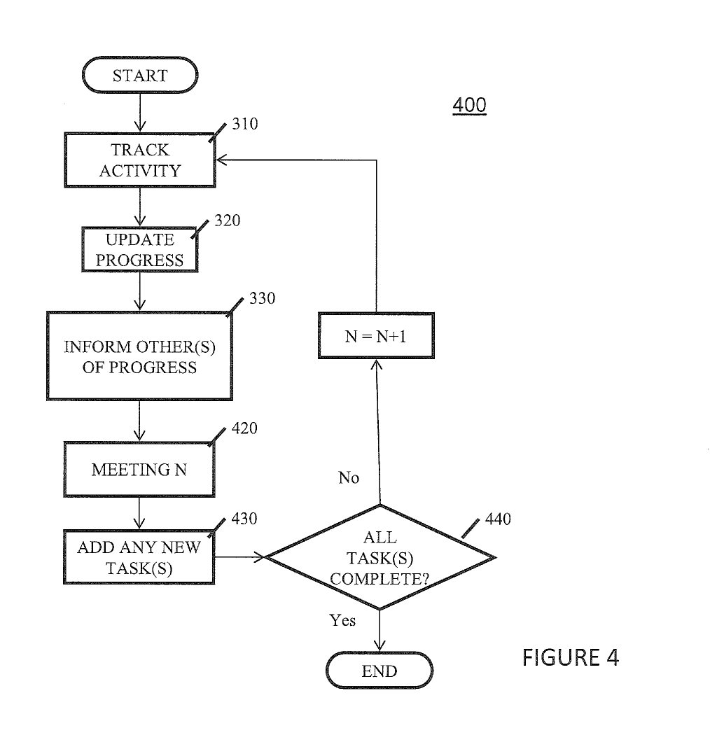

Referring now to FIG. 4, an exemplary embodiment 400 of the present invention is depicted, which adds the feature of reoccurring meetings if all the tasks are not complete. Specifically, at step 420, a meeting called regarding the progress of the task. At step 430, new tasks, if any, are added. At step 440 a determination is made as to whether all the tasks are complete. If they are then the process ends. If they are not all complete, then the reoccurring meeting continues and the activity then a same or substantially similar process to that discussed above with respect to FIG. 3 is repeated.

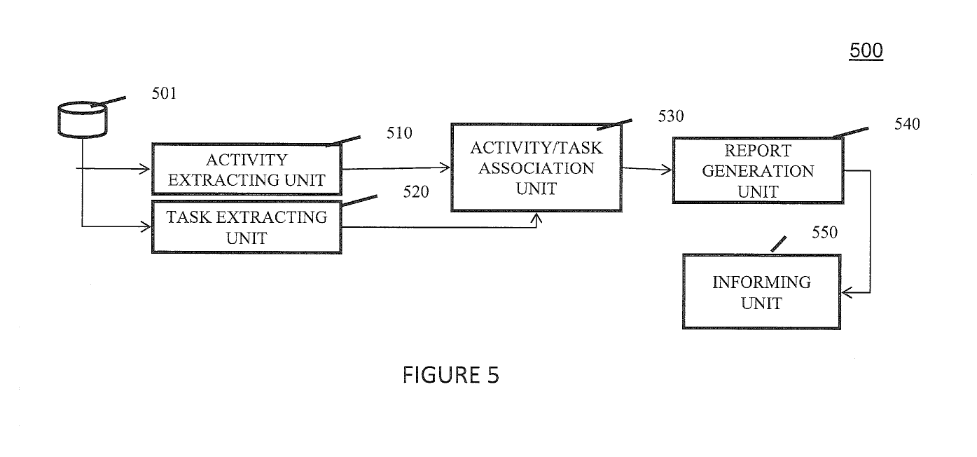

Referring now to FIG. 5, an exemplary system 500 for performing the processes of the aforementioned embodiments is shown. A storage unit 501 stores information. The storage unit 501 may be integrated into the system as software, as a circuit, or as a combination thereof.

The information stored on the storage unit 501 includes information regarding the activity of each entity, as well as information regarding one or more tasks having been set. The one or more tasks may be set in, for example, a meeting, and the meeting may be a reoccurring meeting. Similarly, the one or more tasks may be set prior to (or after) the aforementioned meeting. If the meeting is a reoccurring meeting new tasks may be added as needed.

An activity extracting unit 510 may extract the activity of each entity from the storage unit 501. The activity extracting unit 510 may be integrated into the system as software, as a circuit, or as a combination thereof.

A task extracting unit 520 extracts the tasks from the storage unit 500. The task extracting unit 520 may be integrated into the system as software, as a circuit, or as a combination thereof.

An activity/task association unit 530 associates the activity of each entity having been extracted by the activity extracting unit 510 with the task(s) having been extracted by the task extracting unit 520.

For example, if a first activity and a second activity of a first entity advance a level of progress of a first task and a second task, respectively, then the activity/task association unit 530 associates the first activity with the first task and the second activity with the second task. If a third activity of a second entity is blocking the first entity from engaging in a fourth activity, then the activity/task association unit 530 associates the third activity with the fourth activity by indicating that the fourth activity is being blocked by the third activity. If a third task is being blocked by the second task, then the activity/task association unit 530 associates the third task with the second task by indicating that the third task is being blocked by the second task.

Further, if, for example, the first activity of the first entity includes modifying code relating to the first task, then the activity/task association unit 530 dynamically records which lines of code were modified. Of course the same holds true if the code is added to, deleted, annotated, etc. That is, any change (activity) made by the first entity that is associated with one or more tasks that are related to the change or activity is dynamically recorded by the task association unit 530. The recorded information may be stored in a memory.

Based on the information having been associated in the activity/task association unit 530, a report is generated by the report generation unit 540. This report can include but is not limited to the actual changes (activity) of the entity, a summary of the changes (activity) made by the entity, a summary of annotations added by the entity, the actual annotations added by the entity, a summary of the questions comments the entity has, the actual questions comments the entity has, any combination thereof, etc.

The informing unit 550 sends the report having been generated by the report generation unit 540 to each of the entities. The report can be sent as one or more of an update to a calendar meeting (reoccurring or not), a shared file, a file including any actual changes the first entity made, a file including a summary of any actual changes the first entity made, a file including at least one of a comment made by the first entity regarding the task, a description of the task added by the first entity, documentation of a conversation related to the task, any combination thereof, etc. Similar to the discussion above, each entity can approve their information before it is sent to the other entities.

In some exemplary embodiments, the informing unit 550 pushes the report to a computer associated with each of the entities. In other exemplary embodiments, the informing unit 550 sends the report to the entities in response to a pull request.

According to these features of the present invention, entities are not required to manually track everything they have done since a previous meeting or up to an initial meeting. As a result each of the entities can become more productive by focusing on accomplishing their tasks, rather than noting every little change they make.

Similarly, the report generated by the report generation unit 540 can function as a “cheat sheet” to remind each entity of open issues/questions they may have about the work they have performed. Likewise, when compared with conventional technology, the present inventors have recognized that the report allows others more easily follow along during meetings (especially during fast paced and information intensive meetings).

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module”, “unit” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or to device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

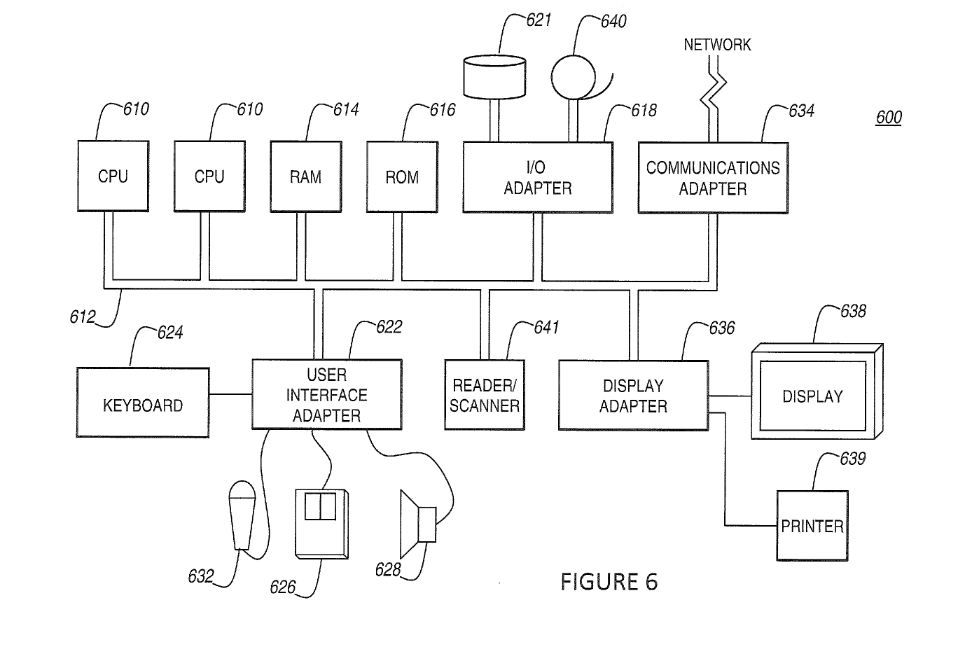

FIG. 6 illustrates a typical hardware configuration 600 which may be used for implementing the inventive cursor control system and method of controlling a cursor. The configuration has preferably at least one processor or central processing unit (CPU) 610. The CPUs 610 are interconnected via a system bus 612 to a random access memory (RAM) 614, read-only memory (ROM) 616, input/output (I/O) adapter 618 (for connecting peripheral devices such as disk units 621 and tape drives 640 to the bus 612), user interface adapter 622 (for connecting a keyboard 624, mouse 626, speaker 628, microphone 632, and/or other user interface device to the bus 612), a communication adapter 634 for connecting an information handling system to a data processing network, the Internet, an Intranet, a personal area network (PAN), etc., and a display adapter 636 for connecting the bus 612 to a display device 638 and/or printer 639. Further, an automated reader/scanner 641 may be included. Such readers/scanners are commercially available from many sources.

In addition to the system described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of storage media.

Thus, this aspect of the present invention is directed to a programmed product, including storage media tangibly embodying a program of machine-readable instructions executable by a digital data processor to perform the above method.

Such a method may be implemented, for example, by operating the CPU 610 to execute a sequence of machine-readable instructions. These instructions may reside in various types of storage media.

Thus, this aspect of the present invention is directed to a programmed product, including storage media tangibly embodying a program of machine-readable instructions executable by a digital data processor incorporating the CPU 610 and hardware above, to perform the method of the invention.

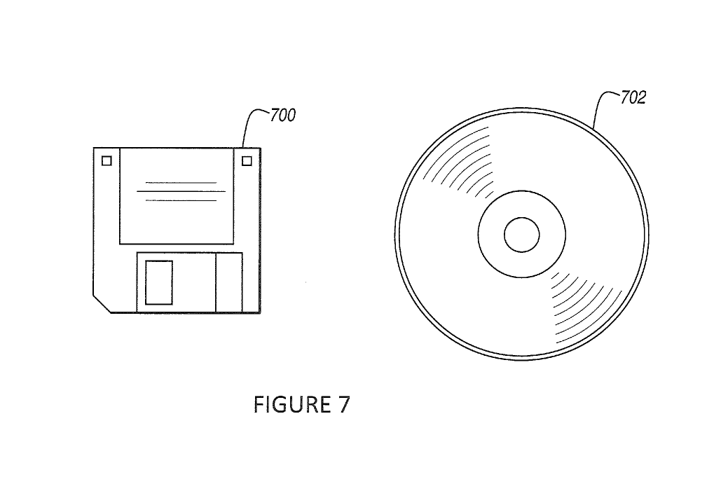

This storage media may include, for example, a RAM contained within the CPU 610, as represented by the fast-access storage for example. Alternatively, the instructions may be contained in another storage media, such as a magnetic data storage diskette 700 or compact disc 702 (FIG. 7), directly or indirectly accessible by the CPU 610.

Whether contained in the computer server/CPU 610, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other suitable storage media. In an illustrative embodiment of the invention, the machine-readable instructions may comprise software object code, compiled from a language such as C, C⁺⁺, etc.

While the invention has been described in terms of several exemplary embodiments, those skilled in the art will recognize that the invention can be practiced with modification within the spirit and scope of the appended claims.

Further, it is noted that, Applicant's intent is to encompass equivalents of all claim elements, even if amended later during prosecution.

What is claimed is:

1. A method of informing a first entity of an activity of a second entity, the method comprising:
tracking, using a processor on a computer, the activity of the second entity during a period between a first time and a second time, the period between the first time and the second time being between a time of a first meeting and a time of a second meeting, the activity including a change made by the second entity that is associated with a task, and the tracking being performed by a processor of a computer system; and
informing the first entity of the activity of the second entity based on the tracking.

2. The method according to claim 1, wherein the first entity and the second entity are members of a reoccurring meeting regarding the task.

3. The method according to claim 1, further comprising generating a report of the activity of the second entity based on the tracking, wherein
the informing of the first entity includes sending the report to the first entity before the time of the second meeting.

4. The method according to claim 1, further comprising informing the second entity of the activity of the second entity before the time of the second meeting.

5. The method according to claim 3, wherein the informing of the first entity includes pushing the report to a computer associated with the first entity before the second meeting.

6. The method according to claim 3, further comprising repeating the tracking and informing for each iteration of a reoccurring meeting, and generating a report of the activity of the second entity that is viewable before each meeting of the reoccurring meeting.

7. The method according to claim 3, further comprising receiving a request for the report and then making the report viewable to the first entity.

8. The method according to claim 1, wherein the second entity comprises a first person that has been invited to the second meeting and does not include anyone that has not been invited to the second meeting.

9. A method of informing each member of a group of one or more activities of one or more other members of the group, the method comprising:
tracking, as executed by a processor on a computer, a first activity of the first member of the group, the first activity being associated with a first task and occurring between a time of a first meeting and a time of a second meeting, and the tracking being performed by a processor of a computer system;
generating a report regarding the first task based on the first activity of the first member; and
sending the report to each member of the group before the second meeting.

10. The method according to claim 9, further comprising tracking a second activity of a second member of the group, the second activity being associated with a second task, and
the report further regards the second task and is further based on the second activity of the second member.

11. The method according to claim 9, wherein the first member of the group comprises a member that has been invited to the second meeting.

12. The method according to claim 9, further comprising recording data associated with the tracking, wherein the report is generated according to the recorded data.

13. The method according to claim 9, further comprising repeating the tracking, the generating, and the sending for each iteration of a reoccurring meeting.

14. The method according to claim 13, further comprising recording data associated with the tracking, wherein
for each iteration of the reoccurring meeting, the data associated with the tracking is modified according to the first activity of the first entity during that iteration.

15. The method according to claim 13, further comprising tracking an activity associated with a new task added from a first iteration of the reoccurring meeting, and
the report further regards the new task and is further based on the activity of any member of the group, which is associated with the new task, if that member of the group has been invited to a second iteration of the reoccurring meeting that occurs after the first iteration of the reoccurring meeting.

16. The method according to claim 9, wherein the report is sent to each member of the group before an occurrence of the second meeting.

17. A method of informing each member of a group of an activity of one or more other members of ther group that occurs during a period between a first iteration of a reoccurring meeting and a second iteration of the reoccurring meeting, the method comprising:
determining, using a processor on a computer, for each member of the group whether they are invited to the second iteration of the reoccurring meeting,
tracking an activity of each member of the group that is associated with a task, the tracking being performed by a processor of a computer system; and
making viewable to each member of the group the activity of every other member of the group, who is invited to the second iteration of the reoccurring meeting, based on the tracking.

18. The method according to claim 17, wherein the activity of every other member of the group, who is invited to the second iteration of the reoccurring meeting is made viewable before a time of the second iteration of the reoccurring meeting.

19. The method according to claim 17, further comprising specifying an application, which a first member of the group uses, as an application from which an activity of the first member of the group is tracked.

20. The method according to claim 17, further comprising receiving an approval from a first member of the group regarding an activity of the first member having been tracked before making the activity of the first member viewable.

21. A method of updating a level of progress of a task, the method comprising:
tracking an activity of a first entity for a time period occurring between a first meeting and a second meeting, the activity being related to the task, and the tracking being performed by a processor of a computer system;
dynamically updating the level of progress of the task based on the activity of the first entity during the time period; and
notifying a second entity having been invited to the second meeting of the updated level progress of the task.

22. The method according to claim 21, further comprising:
setting a milestone related to the task;
determining a first level of progress toward the milestone at or before a beginning of the time period; and
determining a second level of progress toward the milestone at or after an end of the time period, the second level of progress being determined based on the activity of the first entity during the time period, wherein
the dynamic updating of the level of progress includes comparing the first level of progress with the second level of progress.

23. The method according to claim 21, further comprising repeating the tracking and dynamic updating for each iteration of a reoccurring meeting,
wherein the first meeting is a most recent meeting and the second meeting is a next meeting.

24. The method according to claim 21, wherein the first entity comprises an entity that has been invited to the second meeting.

25. The method according to claim 21, wherein the second entity is notified of the updated level of progress of the task using at least one of:
an update to meeting;
a file including any actual changes the first entity made;
a file including a summary of any actual changes the first entity made;
a file including at least one of a comment made by the first entity regarding the task, a description of the task added by the first entity, and documentation of a conversation related to the task.
